(19) United States
(12) Patent Application Publication
(10) Pub. No.: US 2021/0326675 A1
(43) Pub. Date: Oct. 21, 2021

(54) QUESTION-ANSWERING DEVICE AND COMPUTER PROGRAM

(71) Applicant: National Institute of Information and Communications Technology, Tokyo (JP)

(72) Inventors: Jonghoon OH, Tokyo (JP); Kentaro TORISAWA, Tokyo (JP); Canasai KRUENGKRAI, Tokyo (JP); Julien KLOETZER, Tokyo (JP); Ryu IIDA, Tokyo (JP); Ryo ISHIDA, Tokyo (JP); Yoshihiko ASAO, Tokyo (JP)

(21) Appl. No.: 17/252,809

(22) PCT Filed: Jun. 18, 2019
(86) PCT No.: PCT/JP2019/024059

§ 371 Date: Dec. 16, 2020

(30) Foreign Application Priority Data
Jun. 27, 2018 (JP) 2018-122231

(51) Int. Cl. G06N 3/04; G06N 3/08

(52) U.S. Cl. CPC G06N 3/0427; G06N 3/08; G06N 3/0436

(57) ABSTRACT

A memory for a question-answering device that reduces influence of noise on answer generation and is capable of generating highly accurate answers includes: a memory configured to normalize vector expressions of answers included in a set of answers extracted from a prescribed background knowledge source for each of a plurality of mutually different questions and to store the results as normalized vectors; and a key-value memory access unit responsive to application of a question vector derived from a question for accessing the memory and for updating the question vector by using a degree of relatedness between the question vector and the plurality of questions and using the normalized vectors corresponding to respective ones of the plurality of questions.

### TECHNICAL FIELD

The present invention relates to question-answering devices and, more specifically, to question-answering devices presenting highly accurate answer to a How-question.

### BACKGROUND ART

Question-answering systems using a computer to output an answer to a question given by a user are becoming widely used. Questions may be classified into “factoid” questions and non-“factoid” questions. A “factoid” question expects an answer that defines something that the “what” represents such as a name of a place, a name of a person, date, number and so on. In short, answers will be a word or words. A non-“factoid” question expects other types of answers that the “what” cannot represent such as a reason, a definition, a method and so on. An answer to non-“factoid” questions are expressed as a relatively long sentence or a passage including several sentences

As can be seen from the fact that some type of the question-answering systems providing answers to “factoid” questions beats human contestants in a game show, there are many systems that gives highly accurate answers in a very short time. On the other hand, non-“factoid” questions are further classified to “why” questions, How-questions and so on. Among these, obtaining answers to How-questions by a computer has been recognized as a very challenging task that requires highly advanced natural language processing in the field of computer science. As used herein, a How-question is a question asking a process for achieving a goal, for instance, “How can we make potato chips at home?”

How-question answering systems use a technique of extracting answers to How-questions from a huge number of documents prepared in advance. How-question answering systems are expected to play a very important role in the fields of artificial intelligence, natural language processing, information retrieval, Web mining, data mining and so on.

Answers to How-questions are often given in a plurality of sentences. By way of example, an answer to the above question “How can we make potato chips at home?” may be “First, clean potatoes and peel them. Then, slice the potatoes thin with a slicer or the like. Soak them lightly in water to remove starch. Dry the potato slices with a kitchen towel, and cook them twice with oil.” This is because an answer to a How-question is required to explain a series of actions/events. Nevertheless, answers to How-questions are hard to find because it is hard to find clues except expressions indicating an order, such as “first” and “then.” Therefore, a question-answering system that can provide answers to How-questions with higher accuracy by some means is desired.

Meanwhile, in order to enable a neural model to store larger amount of information, recently, Non-Patent Literature 1 listed below proposes a Memory Network including a neural network with an additional memory, which have been used for “Machine comprehension” and “question-answering on knowledge base” tasks. Further, Non-Patent Literature 2 listed below proposes a key-value memory network, which is an improvement on the Memory Network, for storing various types of information in the memory.

### CITATION LIST

### Non-Patent Literature

NPL 1: Sukhbaatar, S., Szlam, A., Weston, J., and Fergus, R. (2015). End-to-end memory networks. In NIPS, 2015.
NPL2: Alexander Miller, Adam Fisch, Jesse Dodge, Amir-Hossein Karimi, Antoine Bordes, and Jason Weston. 2016. Key-value memory networks for directly reading documents. In Proceedings of the 2016 Conference on Empirical Methods in Natural Language Processing, pages 1400-1409.

### SUMMARY OF INVENTION

### Technical Problem

Conventional techniques for specifying answers to How-questions all adopt machine-trained classifiers. Of these techniques, those using machine leaning such as SVM and not using neural networks show low performance. Non-“factoid” question-answering techniques using neural networks also have room for further improvement.

For improving the performance, in key-value memory network disclosed in Non-Patent Literature 2 stores pieces of information as key-value pairs in a memory, and results of processing of each of the pairs in the memory are combined and also used as related information for generating answers. By skillfully using this, the accuracy of answers to How-questions may possibly be improved. Current key-value memory network, however, has a problem that when the pieces of information stored as values in the memory have much noise, the related information obtained from the memory comes to have biased values because of the noise, leading to lower accuracy of answers. Non-Patent Literature 2 listed above uses a pre-prepared knowledge base for obtaining answers and, therefore, it takes no account on noise. Therefore, if background knowledge has noise, accuracy of answers lowers significantly. Such undesirable influence of noise should be removed as much as possible.

Therefore, an object of the present invention is to provide, in a How-question-answering system utilizing a key-value memory network, a question-answering device capable of generating answers with high accuracy while lowering influence of noise on answer generation.

### Solution to Problem

According to a first aspect, the present invention provides a question-answering device, including: a background knowledge extracting means for converting a How-question into a plurality of mutually different types of questions, and for each of the plurality of questions, extracting, from a prescribed background knowledge source, background knowledge to be an answer; an answer storage means configured to normalize vector expressions of answers included in a set of answers extracted by the background knowledge extracting means, for storing results as normalized vectors in association with each of the plurality of questions; an updating means responsive to a question vector as a vector of the How-question being applied, for accessing the answer storage means, and using a degree of relatedness between the question vector and the plurality of questions and using the normalized vectors for respective ones of the plurality of questions, for updating the question vector; and an answer determining means for determining an answer candidate for the How-question based on the question vector updated by the updating means.

Preferably, the updating means includes: a first degree of relatedness calculating means for calculating a degree of relatedness between the question vector and the vector expression of each of the plurality of questions; and a first question vector updating means for calculating a first weighted sum vector as a weighted sum of the normalized vectors stored in the answer storage means, using the degree of relatedness calculated by the first degree of relatedness calculating means for the question corresponding to the normalized vector as a weight, and for updating the question vector by a linear sum of the first weighted sum vector and the question vector.

More preferably, the first degree of relatedness calculating means includes an inner product means for calculating the degree of relatedness by an inner product between the question vector and the vector expression of each of the plurality of questions.

Further preferably, the question-answering device further includes: a second degree of relatedness calculating means for calculating a degree of relatedness between the updated question vector output from the first question vector updating means and the vector expression of each of the plurality of questions; and a second question vector updating means for calculating a second weighted sum vector as a weighted sum of the normalized vectors stored in the answer storage means, using the degree of relatedness calculated by the second degree of relatedness calculating means for the question corresponding to the normalized vector as a weight, for further updating the updated question vector by a linear sum of the second weighted sum vector and the question vector and outputting the further updated question vector.

Preferably, the updating means is formed of a neural network of which parameters are determined by training.

More preferably, the question-answering device further includes: a degree of word importance calculating means for calculating, for a set of answers extracted by the background knowledge extracting means, an index indicating degree of importance of each word using tfidf (term frequency-inverse document frequency) of words appearing in the set; and an attention means for calculating, for each of the plurality of questions used for extracting the background knowledge, an attention matrix having as elements the indexes calculated by the degree of word importance calculating means for each word included in the question; wherein an answer candidate is multiplied by the attention matrix to produce a vector expression, which is input to the answer estimating means.

According to a second aspect, the present invention provides a computer program causing a computer to function as any of the above-described question-answering devices.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a schematic illustration showing a configuration of the core part of the key-value memory network described in Non-Patent Literature 2.

FIG. 2 is a schematic illustration showing background knowledge of tool-goal relation used by the question-answering system in accordance with an embodiment of the present invention.

FIG. 3 is a schematic illustration showing background knowledge of causal relation used by the question-answering system in accordance with an embodiment of the present invention.

FIG. 4 is a schematic illustration showing a process of generating a “factoid” question and a “why” question from a How-question, in the question-answering system in accordance with the present invention.

FIG. 5 illustrates that noises can be stored as values in the key-value memory in the question-answering system.

FIG. 6 is a schematic illustration showing a process for obtaining the configuration of the core part of chunked key-value memory network in the question-answering system in accordance with an embodiment of the present invention.

FIG. 7 is a block diagram showing a functional configuration of the question-answering system adopting 1-layer (1-hop) chunked key-value memory network, demonstrating the configuration of a question-answering system 380 in accordance with an embodiment of the present invention.

FIG. 8 is a block diagram showing a functional configuration of a background knowledge extracting unit shown in FIG. 7.

FIG. 9 is a block diagram showing a functional configuration of a question encoder shown in FIG. 7.

FIG. 10 is a block diagram showing a functional configuration of an answer candidate encoder shown in FIG. 7.

FIG. 11 is a block diagram showing a functional configuration of an attention calculating unit shown in FIG. 10.

FIG. 12 is a block diagram showing a functional configuration of a background knowledge encoder shown in FIG. 7.

FIG. 13 is a block diagram showing a functional configuration of a key-value memory access unit shown in FIG. 7.

FIG. 14 is a block diagram showing a functional configuration of a question—answering system adopting a 3-layer (3-hop) chunked key-value memory network in accordance with an embodiment of the present invention.

FIG. 15 shows, in the form of a table, results of experiments of the system shown in FIG. 14 in comparison with other systems.

FIG. 16 shows an appearance of a computer realizing the question-answering system in accordance with various embodiments of the present invention.

FIG. 17 is a hardware block diagram showing an internal configuration of the computer shown in FIG. 16.

### DESCRIPTION OF EMBODIMENTS

In the following description and in the drawings, the same reference characters denote the same components. Therefore, detailed description thereof will not be repeated.

The embodiments described below propose new neural models of determining answers to How-questions using background knowledge including the “tool/goal relations” and the “causal relations” obtained from a large-scale text corpus for specifying answers. In the task of obtaining an answer to a How-question, the use of background knowledge has never been taken into consideration. In the system described in Non-Patent Literature 2, data generated from a knowledge source is stored in the key-value memory network. Of the data, key is an agent (subject)+relation and the value is object (object). Such pieces of information must be prepared beforehand to be in the form of knowledge in accordance a prescribed format.

As mentioned above, in the embodiments as will be described in the following, the “tool/goal relations” and the “causal relations” are used as background knowledge for specifying an answer. The present invention, however, is not limited to such embodiments. If the field of a question is known, the relations appropriate for the field may be used.

Further, in the embodiments, the background knowledge obtained in this manner is stored in a “chunked key-value memory network,” which is a developed version of the key-value memory network, and used for generating answers.

In the following, first, an example will be described in which the question-answering system is realized by adopting the basic concept of question-answering system in accordance with Non-Patent Literature 2. As will be described later, in the embodiments of the present invention, from an input question, a “factoid” question and a “why” question are generated and applied to an existing question-answering system (that is capable of responding at least to the “factoid” question and the “why” question), and a plurality of answers are obtained for each of the questions.

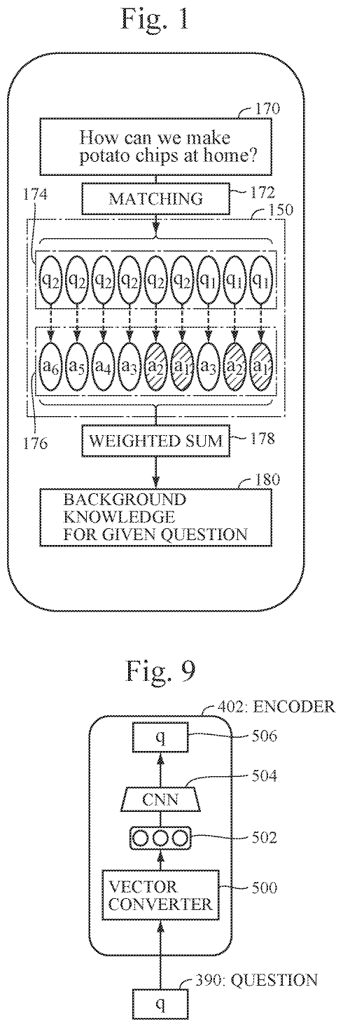

By way of example, referring to FIG. 1, assume that a question 170 (“How do we make potato chips at home?”) is given. From this question 170, a “factoid” question q1 “By what do we make potato chips at home?” and a “why” question q2 “Why do we make potato chips at home?” are obtained. Assume that these questions are given to an existing question-answering system, and that answers a1 to a3 are obtained to question q1 and answers a1 to a6 to question q2.

Key-value memory 150 includes a key memory 174 and a value memory 176. In key-value memory 150, the sets of question and answer obtained in this manner are stored, each set being associated in a one-to-one relationship. More specifically, each question is stored in key memory 174 and each corresponding answer is stored in value memory 176. These memories are refreshed every time a new question is input.

As will be described later, all questions and answers are converted into vector expressions having continuous values as elements. When a question 170 is given, question 170 is matched 172 with each of the questions stored in key memory 174. Here, matching is a process of calculating an index of degree of relatedness between vectors and, typically, the inner product of vectors is used. The inner product value is used as a weight of each answer, and weighted sum 178 of vectors representing respective answers is calculated. The weighted sum 178 will be background knowledge 180 for the given question 170. Using this background knowledge 180, question 170 is updated with a prescribed function. By this updating, at least part of the information represented by the background knowledge comes to be incorporated in question 170. As will be described later, the matching process, the process of calculating weighted sum and the updating process are repeated several times. A prescribed calculation is made between the eventually obtained question and each answer candidate, and a score (typically a probability) indicating whether or not the answer candidate is a correct answer to question 170 is output. Typically, this process is a classification problem into two classes, that is, a “correct answer class” and a “wrong answer class” and the probability that each answer candidate belongs to each class is output as the score. Answer candidates are sorted in a descending order of the scores and the answer candidate at the top is output as the final answer to the HOW-question.

[Acquisition of Background Knowledge]

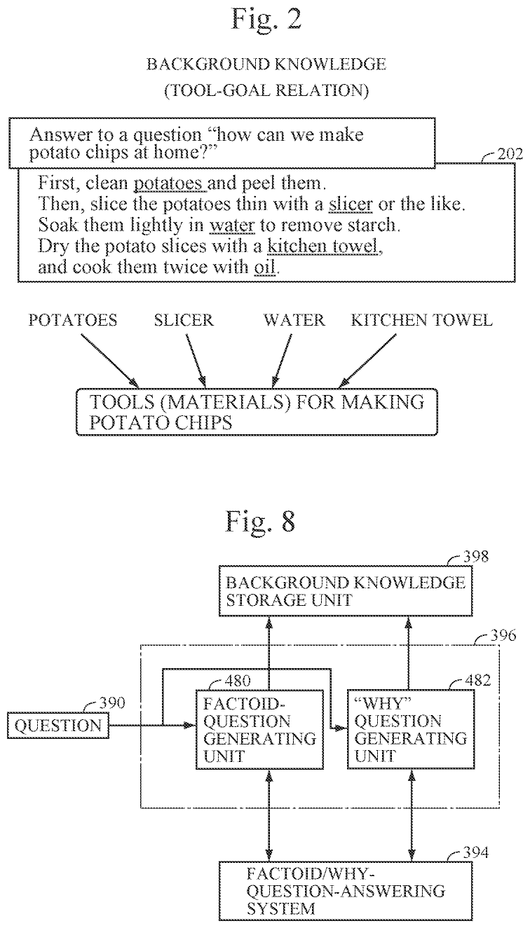

An answer to a How-question describes a process including a series of actions/events for achieving the asked goal. These actions and events are often taken or held with some tools. By way of example, with reference to FIG. 2, answer 202 to the question “How do we make potato chips at home?” includes “potatoes,” “slicer,” “water,” “kitchen towel” and “oil” as tools for making potato chips. Therefore, the “tool-goal” relation such as “make potato chips (goal) with potatoes (tool)” can be used as a clue for specifying an answer to a How-question. Such a relation can automatically be acquired from the source text, by acquiring the semantic relation between nouns based on patterns (for which existing technique is applicable). Specifically, a relation between a product B and a tool (material) A can automatically be acquired by searching for a pattern such as “make B by A”.

In the embodiments below, in order to obtain knowledge of the “tool-goal” relation, a given How-question is converted into a “by what” question. Then, the converted “by what” question is input to an existing “factoid” question-answering system implemented by the applicant. An original sentence for an answer obtained from this system is used as a knowledge source of the “tool-goal relation.” For example, a How-question “How do we make potato chips at home?” can be converted into a “by what” question, that is, “By what do we make potato chips at home?” By inputting this “by what” question to the “factoid” question answering system, an answer “potato” and the source sentence of the answer (such as “we made potato chips by potatoes sent from papa's parents”) are obtained. Then, a pair of “by what” question and the source sentence of the answer is used as a knowledge source representing the “tool-goal” relation for “How do we make potato chips at home?” Naturally, several methods for converting a question may be used. Specifically, from one HOW-question, two or more “factoid” questions or “why” questions may be generated and answers to these questions may be acquired from an existing question-answering system.

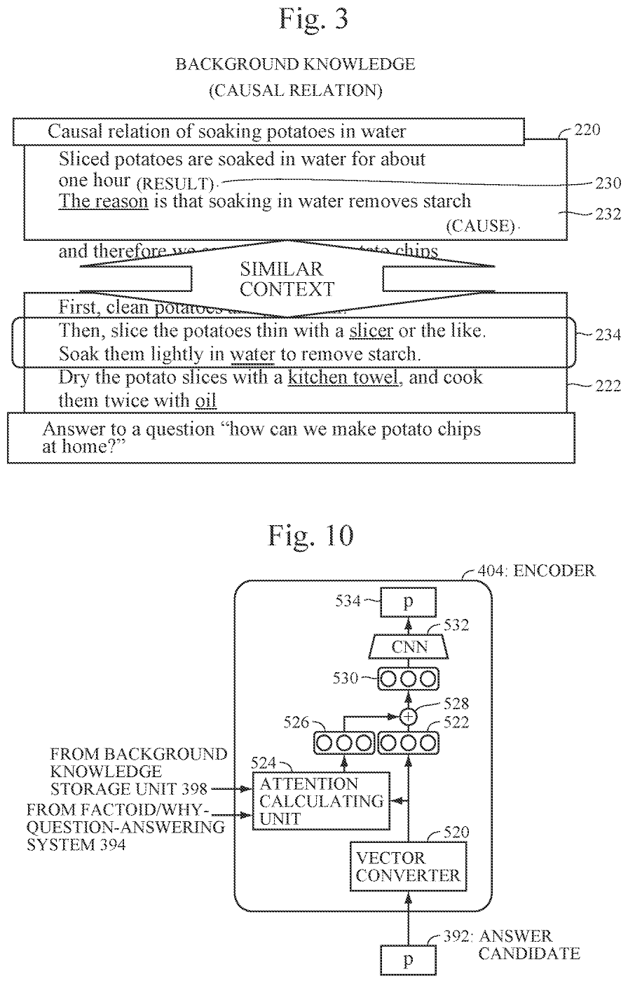

Further, the causal relation representing a reason why some tool is used for a goal may be used as the clue information. For example, referring to FIG. 3, sentences 220 “Sliced potatoes are soaked in water for about one hour (result). The reason is that soaking them in water removes starch and therefor we can make crispy potato chips (cause).” describe the reason why we soak potatoes in water as a causal relation between a passage 232 as a cause and a passage 230 as a result. Specifically, these sentences include context information that matches a part 234 of answer 222 to the question “How do we make potato chips?” Such context can be used as a knowledge source for specifying an answer to a How-question.

In the embodiments below, in order to obtain the above-described causal relation, a How-question is converted into a “why” question and input to a “why” question-answering system practically used by the applicant. An answer to the “why” question is used as a causal relation knowledge source matching the How-question.

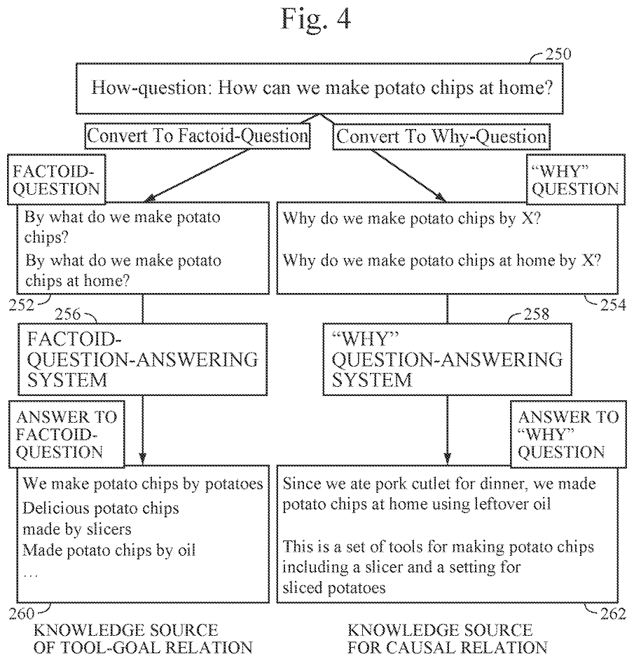

In summary, referring to FIG. 4, in the embodiments below, a How-question 250 (such as “How do we make potato chips at home?”) is converted into a “factoid” question 252 and a “why” question 254. These are input to a “factoid” question-answering system 256 and a “why” question-answering system 258, respectively. If there is an existing question-answering system that can output answers both to “factoid” question 252 and “why” question 254, it may be used as the system integrating “factoid” question-answering system 256 and a “why” question-answering system 258. As a result of this process, a group of answers 260 is obtained from “factoid” question-answering system 256 and a group of answers 262 is obtained from “why” question-answering system 258. These can be used as a knowledge source for the tool-goal relation and a knowledge source for the causal relation, respectively.

The texts representing the tool-goal relation or causal relation obtained by the above-described method provide useful information for obtaining an answer to a How-question. On the other hand, information obtained from these texts may include pieces of information not at all related to the How-question. These are noises.

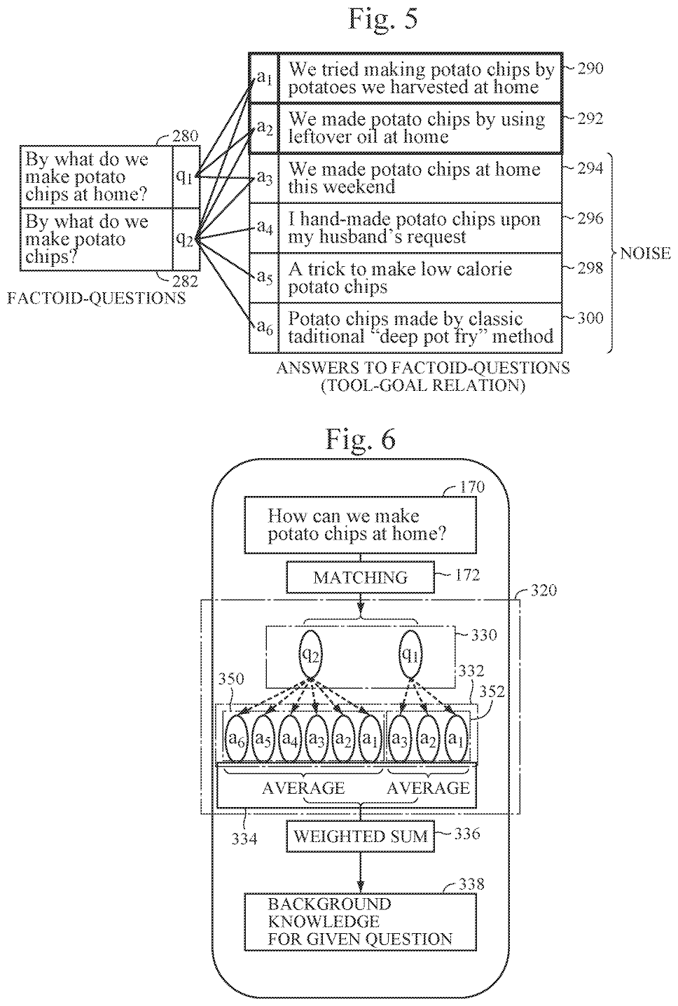

Referring to FIG. 5, assume that answers 290, 292 and 294 are obtained to a “factoid” question 280, and that answers 296, 298 and 300 are obtained in addition to answers 290, 292 and 294 to a “factoid” question 282. Of these answers, answers 290 and 292 are useful as the background knowledge of How-question, while answers 294, 296, 298 and 300 are meaningless as the background knowledge of How-question. Namely, these are noises. It is difficult to obtain highly accurate answers to How-questions unless the influence of such information is removed as much as possible. Such a situation is not taken into consideration in Non-Patent Literature 2.

In order to solve this problem, in the embodiments below, pieces of information of the tool-goal relation and the causal relation are normalized for each question used for obtaining these pieces of information, and a neural model referred to as a “chunked key-value memory network” is used for specifying answers. Normalization as used herein averages a plurality of answers obtained for one question to produce an answer to the question.

Specifically, referring to FIG. 6, in the present embodiment, in place of key-value memory 150 shown in FIG. 1, a chunked key-memory 320 is used. Chunked key-memory 320 includes, as does key-value memory 150, a key memory 330 and a value memory 332.

As in the example of FIG. 1, key memory 330 stores questions (for example, questions q1 and q2) as the key. As in the example of FIG. 1, value memory 332 stores a group of answers 350 to question q1 and a group of answers 352 to question q2. Different from key-value memory 150 shown in FIG. 1, chunked key-value memory 320 includes an averaging unit 334 that averages answers to one same question to produce an average answer. Specifically, as shown in FIG. 6, to question q1, answers a1 to a3 included in the group of answers 352 are averaged to produce an answer vector, and to question q2, answers a1 to a6 included in the group of answers 350 are averaged to produce an answer vector. Weighted sum 336 of these answer vectors is calculated by multiplying weights calculated for questions q1 and q2, and as a result, background knowledge 338 for the given HOW-question is obtained. In order to realize such calculations, all the questions and the answers must be converted into vector expressions. The chunked key-value memory network can be regarded as an improvement on key-value memory network disclosed in Non-Patent Literature 2.

Generally, if answers to a certain question are numerous, the answers tend to be noisy. By contrast, if the number of answers to a question is small, the answers are believed to be less noisy. If weighted sum is calculated by multiplying the same weight both to relevant answers and to the noise answers ignoring such situations, there would be considerable influence of noise. On the other hand, when answers to a certain question is averaged as described above, the weights for the answers to a question having many answers will be smaller compared with those of answers to a question having few answers. Therefore, when weighted sum is further calculated on these answers, the influence of noise on the result becomes relatively smaller, and the probability of eventually obtaining a relevant answer becomes higher.

Specifically, a set M={(ki, vi)} of pairs of questions (keys) and answers (values) stored in chunked key-value memory 320 is converted into a set C of key-chunks as represented by the following equation. Namely, values (answers) forming pairs with a key k′ⱼ of a certain value are collected to form a set Vⱼ, and a chunk cⱼ as an average of each of the answers corresponding to the key k′ⱼ is calculated.

$$\begin{matrix}C = \{ ( {k}_{j}^{′} , {V}_{j} ) \vert {V}_{j} = \{ {v}^{′} \vert ( {k}_{j}^{′} , {v}^{′} ) ∈ M \} \} & ( 1 ) \\ {c}_{j}^{m} = {W}_{υ}^{m} \frac{{\sum }_{v ∈ {V}_{j}} v}{\vert {V}_{j} \vert} + {W}_{k}^{m} {k}_{j}^{′} & ( 2 )\end{matrix}$$

where W^{m}ᵥ∈R^{d′×d′} and W^{m}ₖ∈R^{d′×d′} are both matrices of which element values are determined by training (as will be described later, this embodiment is realized by a neural network), m is called a hop number indicating the number of iterations of readings from the key-chunks and the updating of the questions. c^{m}ⱼ represents a chunk calculated for the key k′ⱼ in the m-th updating. Here, d′ is the number of dimensions output by each CNN.

In the embodiments of the present invention as will be described below, as in the key-value memory network, the degree of relatedness between the input question and the questions in the chunked key-value memory network are calculated, which are used as weights in calculating the weighted sum of the average (chunk) of the answers to each question, and by a prescribed operation on the original question and the weighted sum, the question is updated. After repeating the process one or more times, the finally resulted question will undergo a prescribed operation with the answer candidate, whereby a label or a probability is output which indicates whether or not the answer candidate is a correct answer to the question. The number of this iteration is the hop number m. As will be described later, in the first embodiment, m=1, and in the second embodiment, m=3.

As will be described later, the question-answering device to a How-question in accordance with each of the embodiments can be realized by an end-to-end neural network except for the configuration of obtaining background knowledge from another question-answering system and storing it in the chunked key-value memory network. In this neural network, one layer corresponds to one hop.

### First Embodiment

<Configuration>

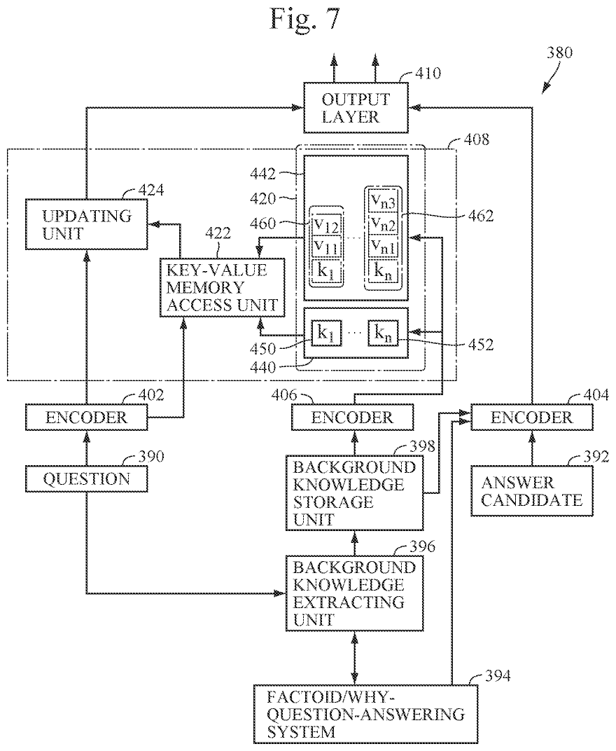

For easier understanding of the embodiment, first, configuration of a question-answering system having only one intermediate layer will be described. Referring to FIG. 7, a question-answering system 380 in accordance with the first embodiment includes a background knowledge extracting unit 396 for receiving a question 390, generating a “factoid” question and a “why” question from question 390, applying these questions to an existing factoid/why question-answering system 394 and thereby extracting background knowledge. Here, the background knowledge refers to a set of pairs of the question applied to background knowledge extracting unit 396 and an answer to the question obtained from factoid/why question-answering system 394.

Question-answering system 380 further includes: a background knowledge storage unit 398 for temporarily storing the background knowledge extracted by background knowledge extracting unit 396; and an encoder 406 for converting each question and answer forming the background knowledge stored in background knowledge storage unit 398 into word embedded vector sequences and further converting each word embedded vector sequence into a vector.

Question-answering system 380 further includes: an encoder 402 for converting question 390 into a word embedded vector sequence and further to a vector; an encoder 404 for converting answer candidate 392 into a word embedded vector sequence and further to a vector; a first layer 408 having a key-value memory 420, which is a chunked key-value memory network storing the background knowledge vectorized by encoder 406, for updating and outputting a question vector using the question vector and the background knowledge stored in key-value memory 420; and an output layer 410 for performing a prescribed operation between the updated question vector output from first layer 408 and the vector of answer candidate 392 output from encoder 404, and for outputting probabilities of the answer candidate belonging to a correct answer class, that is, the candidate being a correct answer to question 390, and the answer candidate belonging to a wrong answer class as a wrong answer, respectively. As will be described later, key-value memory 420 is configured such that for each of a plurality of different questions, vector expressions of answers included in the set of answers extracted from the background knowledge is normalized and stored as normalized vectors.

FIG. 8 schematically shows a configuration of background knowledge extracting unit 396 shown in FIG. 7. Referring to FIG. 8, background knowledge extracting unit 396 includes: a “factoid” question generating unit 480 for generating a “factoid” question from question 390, applying it to factoid/why question-answering system 394, obtaining an answer from factoid/why question-answering system 394, and storing each answer and “factoid” question as a pair in background knowledge storage unit 398; and a “why” question generating unit 482 for generating a “why” question from question 390, applying it to factoid/why question-answering system 394, obtaining an answer from factoid/why question-answering system 394, and storing each answer and “why” question as a pair in background knowledge storage unit 398. “Factoid” question generating unit 480 and “why” question generating unit 482 generate one, or if possible, several questions, respectively, and obtain one or more answers to each of the questions from factoid/why question-answering system 394.

Referring to FIG. 9, encoder 402 shown in FIG. 7 includes: a vector converter 500 receiving question 390, for converting each of the words forming question 390 into a word embedded vector and outputting a word embedded vector sequence 502; and a convolutional neural network (CNN) 504 receiving and converting the word embedded vector sequence 502 into a question vector 506 (vector q). Various parameters of CNN 504 are to be trained in training of question-answering system 380. As vector converter 500, one trained beforehand is used. In the present embodiment and in the second embodiment, vectors output from CNN all have the same dimensions.

Referring to FIG. 10, encoder 404 shown in FIG. 7 includes: a vector converter 520 receiving answer candidate 392, for converting each word thereof into word embedded vector and outputting a word embedded vector sequence 522; an attention calculating unit 524 for outputting an attention matrix 526 having the degree of relatedness between each word embedded vector and question 390 as elements, based on the background knowledge stored in background knowledge storage unit 398 shown in FIG. 7; an operating unit 528 for performing an operation as will be described later on word embedded vector sequence 522 and attention matrix 526 and outputting an attention-added vector sequence 530 formed of word embedded vectors to which attention is added; and a CNN 532 receiving the attention-added vector sequence 530 as an input and converting the same into an answer candidate vector 534 (vector p) to be output. Parameters of CNN 532 are also are to be trained during the training of question-answering system 380. Vector converter 520 is trained beforehand.

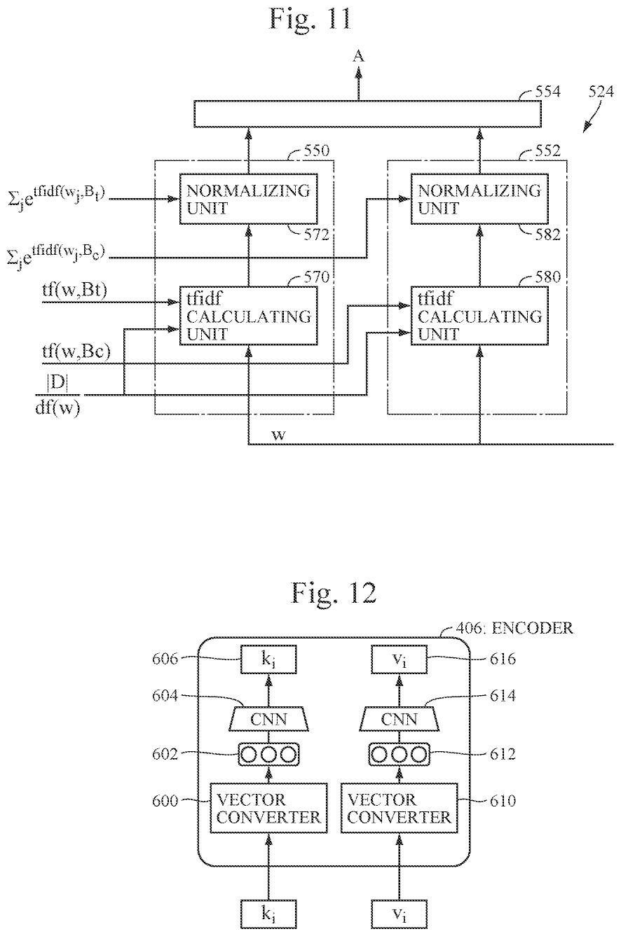

Referring to FIG. 11, attention calculating unit 524 shown in FIG. 10 includes: a first normalized tfidf calculating unit 550 for calculating, for each word w represented by word embedded vector sequence 522 output from vector converter 520, normalized tfidf based on the group of answers to the “factoid” question stored in background knowledge storage unit 398; and a second normalized tfidf calculating unit 552 for calculating normalized tfidf based on the group of answers to the “why” question.

The first normalized tfidf calculating unit 550 includes: a tfidf calculating unit 570 for calculating, for each word w represented by word embedded vector sequence 522 output from vector converter 520, tfidf in accordance with Equation (3); and a normalizing unit 572 for calculating assoc (w, Bt), which is the tfidf calculated by tfidf calculating unit 570 normalized by a softmax function as represented by Equation (4) below. In Equations (3) and (4), Bt represents a set of question-answer pairs obtained by “factoid” question, tf(w, Bt) represents term frequency of word w in set Bt, df(w) represents document frequency of word w in an answer retrieval corpus D held by factoid/why question-answering system 394, and |D| represents the number of documents in corpus D.

$$\begin{matrix}tfidf ( w , Bt ) = ( 1 + log tf ( w , Bt ) ) \times log \frac{\vert D \vert}{d f ( w )} & ( 3 ) \\ assoc ( w , Bt ) = \frac{{e}^{tfidf ( w , Bt )}}{{\sum }_{j} {e}^{tfidf ( {w}_{j} , Bt )}} & ( 4 )\end{matrix}$$

Similarly, the second normalized tfidf calculating unit 552 includes: a tfidf calculating unit 580 for calculating, for each word w represented by word embedded vector sequence 522 output from vector converter 520, tfidf in accordance with Equation (5); and a normalizing unit 582 for normalizing the tfidf calculated by tfidf calculating unit 580 in accordance with Equation (6). In Equations (5) and (6), Bc represents a set of question-answer pairs obtained by “why” question.

$$\begin{matrix}tfidf ( w , Bc ) = ( 1 + log tf ( w , Bc ) ) \times log \frac{\vert D \vert}{d f ( w )} & ( 5 ) \\ assoc ( w , Bc ) = \frac{{e}^{tfidf ( w , Bc )}}{{\sum }_{j} {e}^{tfidf ( {w}_{j} , Bc )}} & ( 6 )\end{matrix}$$

Attention matrix 526 shown in FIG. 10 has the elements obtained by Equation (4) in the first row and the elements obtained by Equation (6) in the second row. Attention matrix 526 is represented as attention matrix A. Operating unit 528 shown in FIG. 10 performs the following operation on word vector sequence Xp to obtain attention-added vector sequence ˜Xp (the sign “˜” is shown directly above the immediately following character in the Equation).

\tilde{X}ₚ=ReLu(Xₚ+WₐA)
(\tilde{X}ₚ∈ [symbol] ^{d×|P|})

where d represents the dimension of word embedded vector representing each word of question and answer used in the present embodiment and |p| represents the number of words forming an answer candidate. Wa is a weight matrix of d rows by 2 columns, of which parameters are to be trained.

The thus obtained answer candidate vector ˜Xp is the attention-added vector sequence 530 shown in FIG. 10. CNN 532 receives this attention-added vector sequence 530 as an input and outputs an answer candidate vector 534 representing an answer candidate. Parameters of CNN 532 are to be trained.

Referring to FIG. 12, encoder 406 shown in FIG. 7 includes: vector converters 600 and 610 for converting, for each pair of key (question) and value (answer), the question and its answer into word embedded vector sequences 602 and 612, respectively; and CNNs 604 and 614 converting word embedded vector sequences 602 and 612 into vectors 606 and 616 and outputting these, respectively. Parameters of CNNs 604 and 614 are to be trained. As vector converters 600 and 610, converters trained in advance are used.

Again referring to FIG. 7, the first layer 408 includes: a key-value memory 420 for storing background knowledge formed of pairs of a key (question) and its chunked answer; a key-value memory access unit 422 receiving a vector representing a question from encoder 402, for accessing key-value memory 420 to extract background knowledge; and an updating unit 424 for updating a vector q representing the question output from encoder 402 in accordance with Equation (7) below, using a vector representing the background knowledge extracted by key-value memory access unit 422, and outputting the result as a vector u² embedding information represented by the background knowledge. As will be described later, several layers the same as the first layer 408 may be used stacked one after another, and the process done by each layer is referred to as a hop. Updating units 424 of these layers are collectively called a controller. The controller can also be implemented by a neural network. The m-th hop is referred to as m-th hop and the state of controller after m-th hop is denoted by u^{m}. The first state of the controller, however, is the vector q output from encoder 402, and q=u¹ (m=1). Further, output vector from key-value memory access unit 422 of the m-th layer is represented by o^{m}. In the present embodiment, m=1. Thus, the state of controller after updating by the first layer 408 is u².

u^{m+1}=Wᵤ^{m}(0^{m}+u^{m}) (7)

In Equation (7), the matrix W^{m}ᵤ acting on the linear sum of o^{m} and u^{m} is a weight matrix of d′×d′ unique to each hop, which is to be trained. In the present embodiment, the number of hops H=1 and, therefore, only one matrix W¹ᵤ is used.

The first layer 408 further includes a logistic regression layer and softmax function output layer 410, using the vector u² and an answer candidate vector p output from encoder 404 to output the probabilities of the answer candidate belonging to the right answer class and to the wrong answer class to the question, respectively, in accordance with Equations (8) and (9), respectively. Equation (8) below, however, is a general expression assuming hop number=H, and in the present embodiment, H=1, namely, u^{H+1}=u².

z=[u^{H+1};p;u^{H+1T}p]∈ [symbol] ^{2d′+1} (8)=

ŷ=softmax(Wₒz bₒ) (9)

In Equation (9), \hat{ }y is a predicted label distribution. Matrix Wo has 2 rows and 2×d′+1 columns, of which parameters are determined by training together with bias vector bo.

Key-value memory 420 includes a key memory 440 for storing keys 450 and 452, and a value memory 442 for storing answers 460, . . . , 462 to respective keys 450 and 452 as values for the keys.

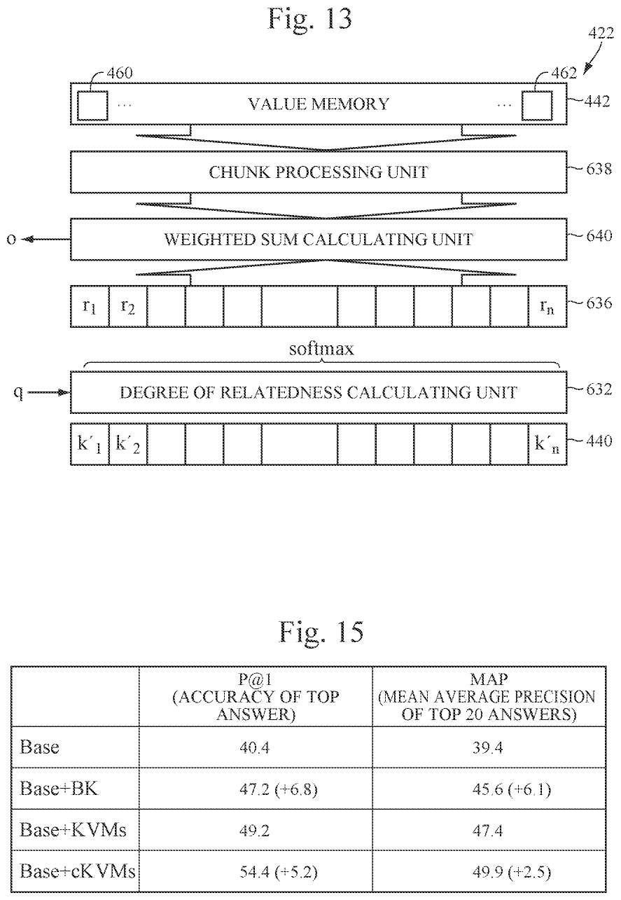

FIG. 13 schematically shows a configuration of key-value memory access unit 422 shown in FIG. 7. Referring to FIG. 13, key value-memory access unit 422 includes: a degree of relatedness calculating unit 632 receiving a vector representing a question q from encoder 402, for accessing key memory 440 of key-value memory 420 shown in FIG. 7, calculating an inner product as an indicator of the degree of relatedness between the vector representing the question and each key, and normalizing it with softmax function and outputting the result; a degree of relatedness storage unit 636 for temporarily storing the degrees of relatedness r1, . . . rn output from degree of relatedness calculating unit 632; a chunk processing unit 638 (corresponding to the averaging unit 334 shown in FIG. 6) averaging (chunking) vectors of answers to the same question in accordance with Equations (1) and (2), for the vectors of respective answers stored in value memory 442; and a weighted sum calculating unit 640 for multiplying the degree of relatedness obtained from the corresponding question stored in degree of relatedness storage unit 636 as a weight by the chunked average answer vector chunked by chunk processing unit 638, calculating the sum and thereby calculating the weighted sum o of the answer.

In place of Equation (7) above, updating may be done in accordance with Equation (10) below.

u^{m+1}=o^{m}⊙T(u^{m})+u^{m}⊙(1−T(u^{m})) (10)
where T(u^{m})=σ(Wₜ^{m}u^{m}+bₜ^{m}), ⊙ represents Hadamard product, and Wₜ^{m}∈ [symbol] ^{d′×d′} and bₜ^{m} are both objects of training.

<Operation>

The question-answering system 380 having the above-described configuration operates in the following manner. Question-answering system 380 has two operation phases, that is, training and inference. First, inference will be described, followed by the description of training.

<Inference>

It is assumed that necessary parameters are all trained before starting inference. Referring to FIG. 7, question 390 and answer candidate 392 are input to question-answering system 380. The results of inference are probabilities of answer candidate 392 belonging to the correct answer class and to the wrong answer class.

Referring to FIG. 8, “factoid” question generating unit 480 converts question 390 into one or more “factoid” questions and applies them to factoid/why question-answering system 394, whereby one or more answers to each question are obtained. “Factoid” question generating unit 480 forms pairs of each of the answers and the corresponding original “factoid” question and stores the pairs in background knowledge storage unit 398. Similarly, “why” question generating unit 482 converts question 390 into one or more “why” questions and applies them to factoid/why question-answering system 394, whereby one or more answers to each question are obtained. “Why” question generating unit 482 forms pairs of each of the answers and the corresponding original “why” question and stores the pairs in background knowledge storage unit 398. Background knowledge storage unit 398 applies each question-answer pair to encoder 406. Background knowledge storage unit 398 calculates tf(w, Bt) from a set Bt of answers to “factoid” question and tf(w, Bc) from a set Bc of answers to “why” question, stored in background knowledge storage unit 398, and outputs them to encoder 404 shown in FIG. 7.

Referring to FIG. 12, for each of the question-answer pairs applied from background knowledge storage unit 398, encoder 406 converts the question into a word embedded vector sequence 602 by vector converter 600, and further to vector 606 by CNN 604. Similarly, encoder 406 converts the answer into a word embedded vector sequence 612 by vector converter 610, and further into vector 616 by CNN 614. Encoder 406 stores each of the pairs of thus converted question vector and answer vector in key-value memory 420. As a result of this process, in the present example, key memory 440 of key-value memory 420 stores keys corresponding to “factoid” questions and keys corresponding to “why” questions, while in value memory 442, answers 460, . . . , 462 forming pairs with these are stored.

Meanwhile, question 390 is applied to encoder 402. Referring to FIG. 9, vector converter 500 of encoder 402 converts question 390 into a word embedded vector sequence 502 and applies it to CNN 504. CNN 504 converts word embedded vector sequence 502 into question vector 506 and applies it to key-value memory access unit 422.

Encoder 404 shown in FIG. 7 receives answer candidate 392 and operates in the following manner. Referring to FIG. 10, vector converter 520 converts answer candidate 392 into word embedded vector sequence 522. Word embedded vector sequence 522 is applied to operating unit 528 and to attention calculating unit 524.

Referring to FIG. 11, tfidf calculating unit 570 of attention calculating unit 524 receives, from background knowledge storage unit 398, tf(w, Bt) calculated from the set Bt of answers to “factoid” question, for each word w of the answer candidate. Further, tfidf calculating unit 570 receives |D|/df(w) from factoid/why question-answering system 394 shown in FIG. 7. From there, in accordance with Equation (3), tfidf calculating unit 570 calculates tfidf(w, Bt) and applies it to normalizing unit 572.

Normalizing unit 572 receives Σⱼe^{tfidf(wj,Bt)} from background knowledge storage unit 398 shown in FIG. 7, calculates assoc(w, Bt) for each word w as the normalized tfidf in accordance with Equation (4), and applies it to matrix generating unit 554.

Further, tfidf calculating unit 580 and normalizing unit 582 of the second normalized tfidf calculating unit 552 calculates assoc(w, Bc) and applies it to matrix generating unit 554, that is, the tfidf normalized in the similar manner as done by tfidf calculating unit 570, using tf(w, Bt) calculated from the set Bc of answers to the “why” question.

Matrix generating unit 554 generates a matrix having assoc(w, Bt) in the first row and assoc(w, Bc) in the second row, and applies it as attention matrix 526 shown in FIG. 10, to operating unit 528.

Operating unit 528 performs the above-described operation using the attention matrix 526 on word embedded vector sequence 522 from vector converter 520, thereby generating attention-added vector sequence 530, which is applied to CNN 532.

In response to this input, CNN 532 outputs answer candidate vector 534 and applies it to an input of output layer 410.

On the other hand, referring to FIG. 13, degree of relatedness calculating unit 632, upon receiving question vector q from encoder 402, calculates the inner product of each key (question vector of background knowledge) stored in key memory 440 and the question vector q and thereby calculates an index of degree of relatedness between the question q and each question vector of background knowledge, and further, normalizes each degree of relatedness with softmax function, and stores the results in degree of relatedness storage unit 636.

Chunk processing unit 638 calculates average of vectors of answers to the same question in accordance with Equations (1) and (2) (chunking), and calculates a normalized answer vector. Here, normalization means calculating an average of vectors of respective answers. Normalization as such has the following advantage. Specifically, if answers included in a set of answers extracted for a certain question is larger in number, the set of answers tend to be noisier. On the other hand, a question having smaller number of answers can be regarded as a right question, and the set of answers thereto is less noisy. Therefore, when the set of answers to each question is normalized, weights of noise answers will be smaller relative to the weights of other answers. Namely, noise in the background knowledge obtained from the knowledge source can be reduced. As a result, the possibility will be higher that the eventually obtained answer is the right answer to the question.

Weighted sum calculating unit 640 calculates weighted sum of answer vectors normalized by chunk processing unit 638 using, as weight, the degree of relatedness stored in degree of relatedness storage unit 636, and outputs the results as vector o to updating unit 424 shown in FIG. 7.

Referring to FIG. 7, updating unit 424 performs an operation between vector o(o¹) and question vector q(u¹) received from encoder 402 in accordance with Equation (7) and applies resulting vector u² to the input of output layer 410.

Output layer 410 performs an operation in accordance with Equation (8) between the attention-added answer candidate vector applied from encoder 404 and the updated question vector u applied from updating unit 424 and outputs the result. The result is the determination result as to whether the answer candidate 392 is a correct answer to the question 390.

<Training>

In the question-answering system 380, processes by encoders 402, 404 and 406 and thereafter are realized by a neural network. First, a large number of pairs of questions and answer candidates to the question are collected, and each pair is used as a training sample. As training samples, both positive examples and negative examples are prepared. A positive example has an answer candidate that is a correct answer to the question, while a negative example does not. Positive and negative examples are distinguished by a label added to each training sample. Parameters of the neural network are initialized by a known method.

As question 390 and answer candidate 392, a question and an answer candidate of a training sample are applied to encoders 402 and 406. Question-answering system 380 executes the same process as the inference process described above, and outputs the result from output layer 410. The result is the probability of the answer candidate belonging to the correct answer class and to the wrong answer class, ranging between 0 and 1. A difference between the label (0 or 1) and this output is calculated and, by error back propagation, parameters of question-answering system 380 are updated.

This process is executed on every training sample, and the resulting answer the accuracy of question-answering system 380 is verified by a verifying data set prepared separately. If the change in accuracy of the verified result is larger than a prescribed threshold value, training is again executed on every training sample. The training ends when the change in accuracy becomes smaller than the threshold value. Alternatively, the training may end when the number of repetitions reaches a prescribed threshold value.

As a result of such process, parameters of various parts forming question-answering system 380 are trained.

### Second Embodiment

In the first embodiment, the hop number H=1, that means memory access by key-value memory access unit 422 and updating of question by updating unit 424 are executed only once. The present invention, however, is not limited to such an embodiment. The hop number may be two or more. Experiments show that a question-answering system with hop number H=3 exhibited the best performance. The second embodiment is an example of H=3.

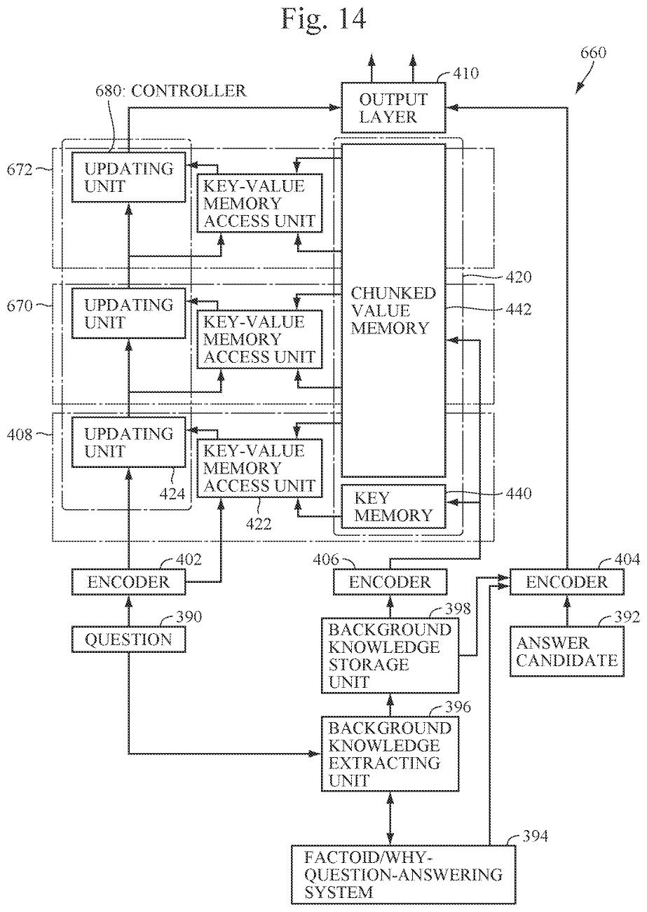

Referring to FIG. 14, a question-answering system 660 in accordance with the second embodiment differs from the configuration of question-answering system 380 shown in FIG. 7 in that it includes the second and third layers 670 and 672, both having the same structure as the first layer 408. Since the structure is the same as that of first layer 408, description thereof will not be repeated here.

As shown in FIG. 14, an output u¹ of updating unit 424 of the first layer 408 is applied to an updating unit and a key value memory accessing unit of the second layer 670. Similarly, an output u² of the updating unit of second layer 670 is applied to an updating unit and a key value memory accessing unit of the third layer 672. An output u³ of the updating unit of third layer 672 is applied to output layer 410 as is the output of updating unit 424 of the first layer 408 in the first embodiment. By these updating units, a controller 680 is formed.

The operation of question-answering system 660 of the second embodiment is like that of the first embodiment except that not only the first layer 408 but also the second and third layers 670 and 672 perform the processes both at the time of inference and training. Therefore, detailed description thereof will not be repeated here.

Key-value memory 420 is commonly used by the first, second and third layers 408, 670 and 672. It is noted, however, that matrixes W^{m}ᵥ and W^{m}ₖ (m=1, 2, 3) of Equation (2) are matrixes different layer by layer and are to be trained.

[Experimental Results]

Experiments were conducted by question-answering systems with the hop number H changed variously. As mentioned above, the best performance was observed when hop number was H=3. FIG. 15 shows the results.

Referring to FIG. 15, Base represents a system in which answer determination is done by a neural network using question and answer only. Base+BK applies the background knowledge obtained by each of the embodiments above to Base. Different from the memory network, however, question is not processed. Base+KVMs indicates a system in which KVMs described in Non-Patent Literature 2 is used for the processing of background knowledge. Base+KVMs corresponds to the question-answering system 660 in accordance with the second embodiment above. Further, P@1 represents accuracy of the top answer, and MAP represents mean average precision of top 20 answers.

Referring to FIG. 15, Base+BK shows improvement of +6.8 point of P@1 and +6.1 point of MAP over Base. Therefore, it can be seen that the background knowledge proposed in the embodiments above is effective in HOW question-answering. Further, as compared with Base+KVMs, Base+cKVMs shows improvement of +5.2 point of P@1 and +2.5 point of MAP. Therefore, it is understood that use of cKVMs in place of KVMs further improves accuracy.

[Computer Implementation]

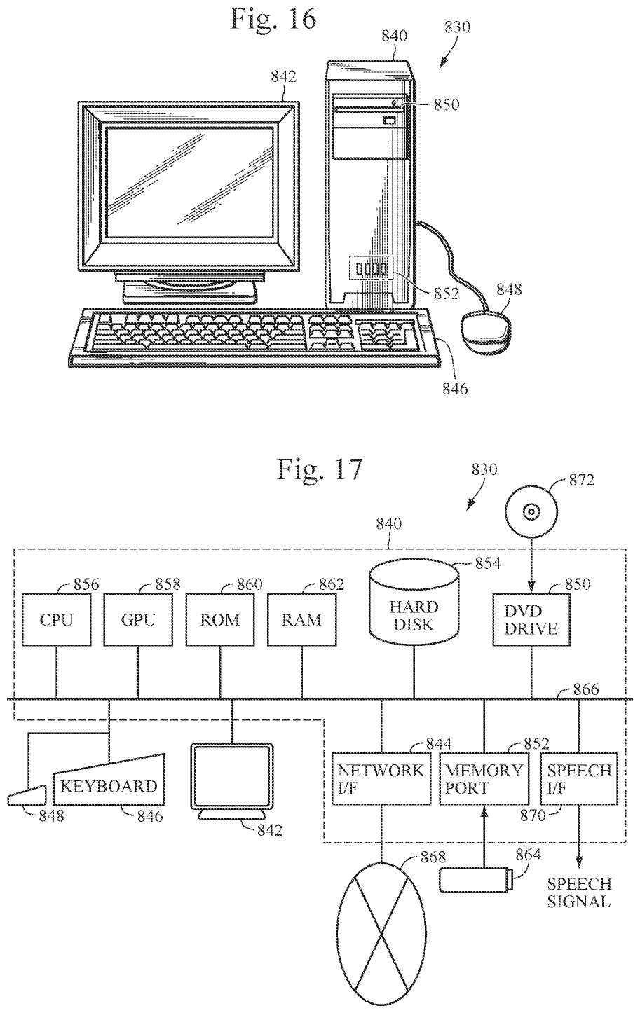

Various functioning units of question-answering system 380 and question-answering system 660 in accordance with the embodiments above can be implemented by computer hardware and programs executed by a CPU (Central Processing Unit) and a GPU (Graphics Processing Unit) on the computer hardware. FIGS. 16 and 17 show computer hardware realizing the devices and systems mentioned above. A GPU is generally used for image processing, and a technique utilizing the GPU for common computing process other than image processing is referred to as GPGPU (General-purpose computing on graphics processing unit). A GPU is capable of executing a plurality of computations of the same type simultaneously in parallel. On the other hand, when a neural network operates, calculation of weight for each node is a simple product-sum operation which can often simultaneously executable in a massively parallel manner. At the time of training, larger amount of computation becomes necessary, which can also be executed in a massively parallel manner. Therefore, a computer having GPGPU is suitable for training of and inference by the neural network forming question-answering systems 380 and 660.

Referring to FIG. 16, computer system 830 includes a computer 840 having a memory port 852 and a DVD (Digital Versatile Disc) drive 850, a keyboard 846, a mouse 848 and a monitor 842.

Referring to FIG. 17, in addition to memory port 852 and DVD drive 850, computer 840 includes a CPU 856 and GPU 858, a bus 866 connected to CPU 856, GPU 858, memory port 852 and DVD drive 850, a read-only memory (ROM) 860 for storing a boot program and the like, a random access memory (RAM) 862 which is a computer-readable storage media connected to bus 866, for storing program instructions, a system program and work data, and a hard disk drive (HDD) 854.

Computer 840 further includes a network interface (I/F) 844 providing a connection to a network 868, enabling communication with other terminals, and a speech I/F 870 for speech signal input from/output to the outside, both connected to bus 866.

The program causing computer system 830 to function as various functional units of the devices and systems of the embodiments above is stored in a DVD 872 or a removable memory 864, both of which are computer readable storage media, loaded to DVD drive 850 or memory port 852, and transferred to HDD 854. Alternatively, the program may be transmitted to computer 840 through network 868 and stored in HDD 854. The program is loaded to RAM 862 at the time of execution. The program may be directly loaded to RAM 862 from DVD 872, removable memory 864, or through network 868. The data necessary for the process described above may be stored at a prescribed address of HDD 854, RAM 862, or a register in CPU 856 or GPU 858, processed by CPU 856 or GPU 858, and stored at an address designated by the program. Parameters of the neural network of which training is eventually completed are stored, together with the program for realizing the training and inference algorithm of the neural network, for example, in HDD 854, or in DVD 872 or removable memory 864 through DVD drive 850 and memory port 852, respectively, or transmitted to another computer or a storage device connected to network 868 through network I/F 844.

The program includes a plurality of instructions causing computer 840 to function as various devices and systems in accordance with the embodiments above. The numerical value calculating process in the various devices and system described above are done by using CPU 856 and GPU 858. Though the process is possible by using CPU 856 only, GPU 858 realizes higher speed. Some of the basic functions necessary to cause the computer 840 to realize this operation are provided by the operating system running on computer 840, by a third-party program, or by various dynamically linkable programming tool kits or program library, installed in computer 840 when the program is run. Therefore, the program itself may not necessarily include all the functions necessary to realize the devices and method of the present embodiments. The program has only to include instructions to realize the functions of the above-described systems or devices by dynamically calling appropriate functions or appropriate program tools in a program tool kit or program library in a manner controlled to attain desired results. Naturally, all the necessary functions may be provided by the program alone.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention improves computer interface such that the computer returns right answers to various questions given by users in natural language related to manufacturing of products, provision of services, research problems and so on, whereby information stored in the computer and computational functions of the computer are made more easily usable, and thus, it leads to improved work efficiency and better qualities of products and services in various and many fields.

### REFERENCE SIGNS LIST

150 key value memory
170, 390 question
172 matching
174, 330 key memory
176, 332 value memory
178 weighted sum
250 How question
252, 280, 282 “factoid” question
254 “why” question
256 “factoid” question-answering system
258 “why” question-answering system
260, 262, 350, 352 group of answers
290, 292, 294, 296, 298, 300 answer
320 chunked key-value memory
334 averaging unit
380, 660 question-answering system
392 answer candidate
394 factoid/why question-answering system
396 background knowledge extracting unit
398 background knowledge storage unit
402, 404, 406 encoder
408 1st layer
410 output layer
420 key-value memory
422 key-value memory access unit
424 updating unit
440 key memory
442 value memory
450, 452 key
460, 462 answer
480 “factoid” question generating unit
482 “why” question generating unit
500, 520, 600, 610 vector converter
502, 522, 602, 612 word embedded vector sequence
504, 532, 604, 614 CNN
506 question vector
524 attention calculating unit
526 attention matrix
528 operating unit
530 attention-added vector sequence
534 answer candidate vector
550 1st normalized tfidf calculating unit
552 2nd normalized tfidf calculating unit
570, 580 tfidf calculating unit
572, 582 normalizing unit
632 degree of relatedness calculating unit
636 degree of relatedness storage unit
638 chunk processing unit
640 weighted sum calculating unit
670 2nd layer
672 3rd layer

1. A question-answering device, comprising:
a background knowledge extracting means for converting a How-question into a plurality of mutually different types of questions, and for each of the plurality of questions, extracting, from a prescribed background knowledge source, background knowledge to be an answer;
an answer storage means configured to normalize vector expressions of answers included in a set of answers extracted by said background knowledge extracting means, for storing results as normalized vectors in association with each of said plurality of questions;
an updating means responsive to a question vector as a vector of said How-question being applied, for accessing said answer storage means, and using a degree of relatedness between the question vector and said plurality of questions and using said normalized vectors for respective ones of said plurality of questions, for updating said question vector; and
an answer determining means for determining an answer candidate for said How-question based on said question vector updated by said updating means.

2. The question-answering device according to claim 1, wherein
said updating means includes
a first degree of relatedness calculating means for calculating a degree of relatedness between said question vector and the vector expression of each of said plurality of questions, and
a first question vector updating means for calculating a first weighted sum vector as a weighted sum of said normalized vectors stored in said answer storage means, using the degree of relatedness calculated by said first degree of relatedness calculating means for the question corresponding to the normalized vector as a weight, and for updating said question vector by a linear sum of said first weighted sum vector and said question vector.

3. The question-answering device according to claim 2, wherein said first degree of relatedness calculating means includes an inner product means for calculating said degree of relatedness by an inner product between said question vector and the vector expression of each of said plurality of questions.

4. The question-answering device according to claim 2, further comprising:
a second degree of relatedness calculating means for calculating a degree of relatedness between the updated question vector output from said first question vector updating means and the vector expression of each of said plurality of questions; and
a second question vector updating means for calculating a second weighted sum vector as a weighted sum of said normalized vectors stored in said answer storage means, using the degree of relatedness calculated by said second degree of relatedness calculating means for the question corresponding to the normalized vector as a weight, for further updating said updated question vector by a linear sum of said second weighted sum vector and said question vector and outputting the further updated question vector.

5. The question-answering device according to claim 1, wherein said updating means is formed of a neural network of which parameters are determined by training.

6. A non-transitory machine-readable medium having stored thereon a computer program causing a computer to function as the question-answering device according to claim 1.
